(19) United States
(12) Patent Application Publication
(10) Pub. No.: US 2019/0151923 A1
(43) Pub. Date: May 23, 2019

(54) Method for Producing a Formed Body

(71) Applicants: ThyssenKrupp Steel Europe AG, Duisburg (DE); thyssenkrupp AG, Essen (DE)

(72) Inventors: Thomas Grosserüschkamp, Duisburg (DE); Michael Gövert, Dortmund (DE); Thomas Flöth, Duisburg (DE)

(21) Appl. No.: 16/300,073

(22) PCT Filed: May 11, 2017
(86) PCT No.: PCT/EP2017/061346

§ 371 Date: Nov. 9, 2018

(30) Foreign Application Priority Data
May 18, 2016 (DE) 10 2016 208 462.3

(51) Int. Cl. B21D 22/16; B21D 22/18; B21D 37/16; B21D 53/10; F16D 3/223

(52) U.S. Cl. CPC B21D 22/16; B21D 22/185; F16D 2250/0023; B21D 53/10; F16D 3/223; B21D 37/16

(57) ABSTRACT

A method for producing a formed body includes providing a round or pre-formed semi-finished product of a steel material, and heating the semi-finished product at least in regions to a first temperature. The method further includes forming a hub on the semi-finished product warm at least in regions, for generating a preform having an upper geometric element. The method further includes heating or re-heating the preform having an upper geometric element at least in regions to a second temperature, and forming a bell on the preform having an upper geometric element warm at least in regions, for generating a preform having an upper and at least one lower geometric element. The method further includes heating or re-heating the preform at least in regions to a third temperature, and profiling the preform warm at least in regions for generating a formed body in a third operative step.

The invention relates to a method for producing a formed body.

Methods for producing formed bodies in particular by means of roller spinning are part of the prior art. For example, a method for producing a rotationally symmetrical component is described in document US 2001/0035036 A1, as to how a component having a hub is fabricated from a round blank by means of roller spinning. For example, methods for producing joint journals or axle journals by means of roller spinning are known from further documents DE 10 2013 101 555 B3 and DE 10 2013 106 268 A1, wherein corresponding formed bodies are produced in a multi-staged roller spinning process from substantially planar blanks of a steel material. The methods mentioned have in common that high forming forces are required for the massive forming and roller spinning systems of corresponding dimensions are necessary.

Proceeding from the prior art, the invention is based on the object of providing a method using forming forces that are reduced in comparison with conventional roller spinning.

The object mentioned above is achieved by a method comprising the following steps:
providing a round or pre-formed semi-finished product of a steel material;
heating the semi-finished product at least in regions to a first temperature,
forming a hub on the semi-finished product warm at least in regions, for generating a preform having an upper geometric element in a first operative step and/or tool by means of roller spinning;
heating or re-heating the preform having an upper geometric element at least in regions to a second temperature;
forming a bell on the preform having an upper geometric element warm at least in regions, for generating a preform having an upper and at least one lower geometric element in a second operative step and/or tool by means of roller spinning;
heating or re-heating the preform at least in regions to a third temperature;
profiling the preform warm at least in regions for generating a formed body in a third operative step and/or tool.

It has been proved that a reduction in the forming forces in comparison to conventional roller spinning is possible in particular when the work piece prior to the forming and/or profiling is heated to a specific temperature. According to a first embodiment of the method according to the invention, the first temperature and/or the second temperature are/is between 200° C. and 700° C., in particular between 250° C. and 580° C. In particular at a temperature above 200° C., preferably above 250° C., lower forming forces in comparison to conventional roller spinning are thus required when forming in particular the hub on the semi-finished product and/or the bell on the preform, since the material becomes softer and, associated therewith, more readily capable of forming as the temperature rises. In the case of a preferred use of hardening-capable steel materials the temperature, depending on the alloy elements, is limited to a maximum of 700° C., in particular to a maximum of 580° C. in order for a modification of the structure, for example in (partial) austenite, in the material to be substantially suppressed. The first and the second temperature can be identical or dissimilar and selected from the temperature range mentioned, preferably depending on the material and the tools and/or degree of forming used.

According to a further embodiment of the method according to the invention, the third temperature is between 400° C. and 1000° C., in particular between 480° C. and 950° C. Apart from the forming forces for profiling the formed body to be generated being lower in comparison to conventional roller spinning, the formed body according to a preferred embodiment of the method according to the invention can be hardened at least in regions during or after the profiling. As a premise to the hardening during profiling it is necessary for the third temperature to be at least Act for a partial austenitization, preferably at least Ac3 for a complete austenitization. Alternatively, the hardening in temporal terms can be performed after profiling, wherein the third temperature in this instance is limited to a maximum of 700° C., in particular to a maximum of 580° C. According to an alternative embodiment of the method according to the invention, on account thereof a boundary hardening can be carried out on the formed body at least in regions, in particular in the internal region of the bell. Hardening-capable steel materials which in the tempered state have a hardness of at least 50 HRC are particularly preferably used. The steel material is preferably composed of the following alloy component parts in % by weight:

| | | |
|---|---|---|
| 0.15 | <= C | <= 0.8; |
| 0.1 | <= Si | <= 1.2; |
| 0.3 | <= Mn | <= 1.8; |
| 0.1 | <= Cr | <= 1.8; |
| 0.05 | <= Mo | <= 0.6; |
| 0.05 | <= Ni | <= 3.0; |
| 0.0005 <= B | <= 0.01; | |
| | Al | <= 0.15; |
| | Ti | <= 0.04; |
| | P | <= 0.04; |
| | S | <= 0.03; |
| | N | <= 0.03; |

iron residues and unavoidable contaminations. HRC is Rockwell hardness and hardness testing is specified in DIN EN ISO 6508-1.

According to a further embodiment of the method according to the invention during the forming the semi-finished product in the first operative step and/or the tool and/or the preform having an upper geometric element in the second operative step and/or tool are/is actively temperature controlled. It can be guaranteed on account thereof that the work piece, even after placing or arranging the warm workpiece, is maintained at a predetermined temperature in the tool by means of suitably disposed and/or integrated means such that rapid cooling of the workpiece can be avoided as compared to a cold tool.

According to a further embodiment of the method according to the invention the forming and/or profiling can in each case be performed in one or a plurality of operative steps. Depending on the complexity of the formed body to be generated, the generation of the desired (pre-)form can be performed in one or in a plurality of tools.

According to a preferred embodiment of the method according to the invention a formed body in the form of a joint journal or axle journal is produced, wherein the profiling in the third tool is performed at least in regions in the lower geometric element or the bell, respectively, of the warm preform, and comprises at least a configuration of one raceway and/or ball races. The profiling in the third tool can be performed by means of roller spinning, wherein the profiling is performed, for example, by means of at least one rest bar and/or at least one profiling roller, or additionally or alternatively in a profiling tool which has at least one forming slide element, for example.

According to a further embodiment of the method according to the invention the heating is performed in an inductive manner. Inductive heat sources can be easily operated in an economical manner and can heat workpieces at least in regions; in particular, the depth of heat treatment can be controlled in a targeted and relatively simple manner. The heating of the respective workpiece is preferably carried out prior to the latter being arranged in or placed into the respective tool and/or prior to carrying out the respective operative step. Alternatively, other heat sources, for example heating the work piece in an oven, are also conceivable. Heating outside the tool is particularly preferable, and the cycle rate can be increased on account thereof.

The invention will be explained in more detail hereunder by means of the drawing illustrating a few exemplary embodiments. Identical parts are provided with the same reference signs. In the drawing:

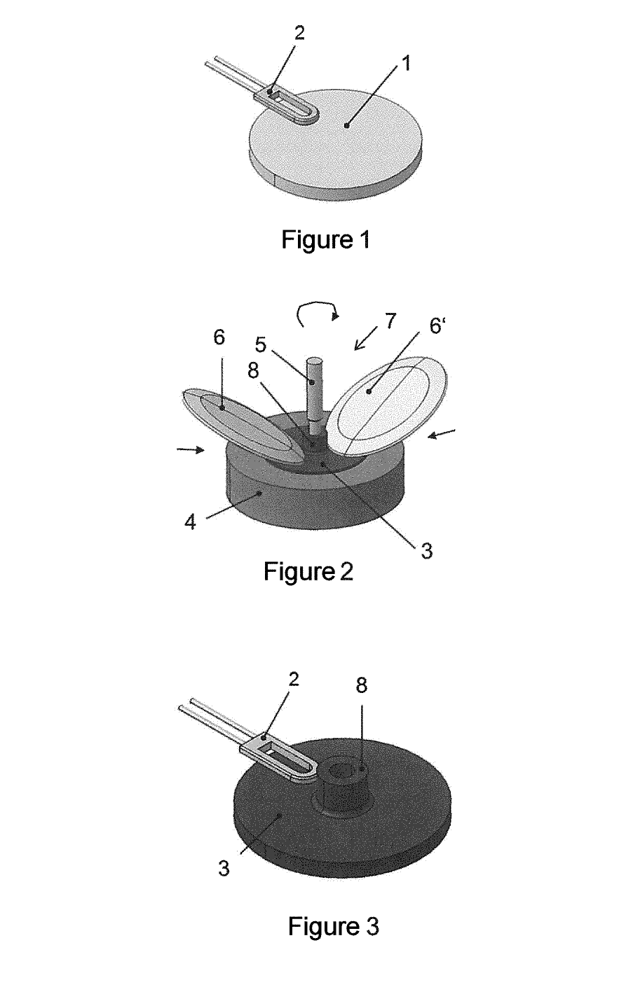

FIG. 1): shows a schematic illustration of an exemplary embodiment at the point in time of heating a semi-finished product;

FIG. 2): shows a schematic illustration of an exemplary embodiment at the point in time of generating a preform having an upper geometric element;

FIG. 3): shows a schematic illustration of an exemplary embodiment at the point in time of heating a preform having an upper geometric element;

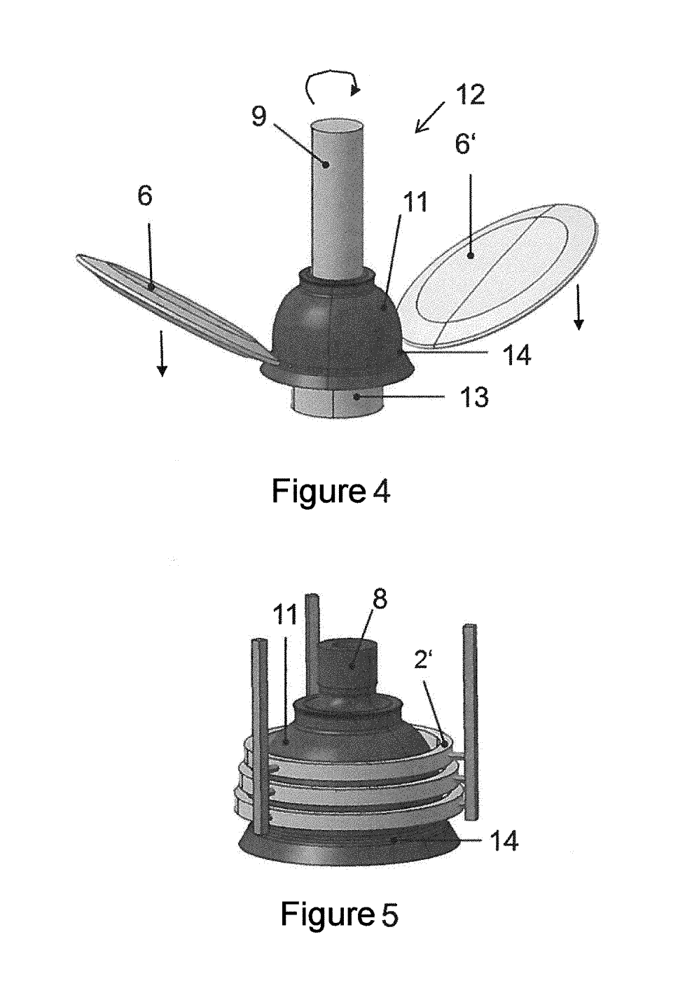

FIG. 4): shows a schematic illustration of an exemplary embodiment at the point in time of generating a preform having an upper and at least one lower geometric element;

FIG. 5): shows a schematic illustration of an exemplary embodiment at the point in time of heating a preform having an upper and at least one lower geometric element;

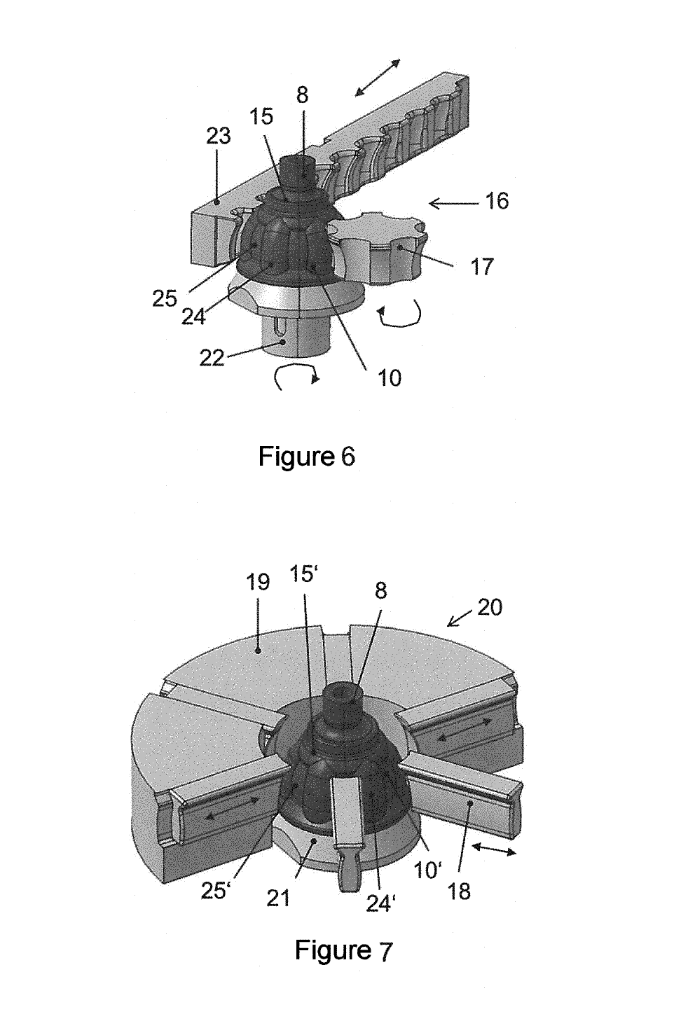

FIG. 6): shows a schematic illustration of a first exemplary embodiment at the point in time of generating a formed body; and

FIG. 7): shows a schematic illustration of a second exemplary embodiment at the point in time of generating a formed body.

In a first step of the method according to the invention a round semi-finished product (1) of a steel material, for example hot-rolled boron-alloyed steel materials, is provided. In order for the forming forces to be reduced as compared to conventional roller spinning, the workpiece/semi-finished product (1) is at least in regions heated to a first temperature which is between 200° C. and 700° C., in particular before the semi-finished product (1) is processed in a first operative step and/or is placed into or arranged in a first tool (7). The heating at least in regions is preferably performed in an inductive manner by means of an inductor (2). For example, the semi-finished product (1) is fed to a device that in a corresponding manner is equipped with at least one inductor (2) [FIG. 1], or the inductor can be disposed on a feed device (not illustrated here) which supplies the first tool (7) with the semi-finished product (1).

The warm semi-finished product (1) is placed into the first tool (7), in particular arranged in a die (4) that is configured in a corresponding manner. The die (4) is disposed so as to be actively rotatable in the first tool (7). After placing the warm semi-finished product (1), a pin-shaped downholding unit (5) is lowered in a centric manner onto the die (4) that is supplied with the semi-finished product (1), said down holding unit (5) fixing the semi-finished product (1) so as to be secured against rotation in the die (4). At least one push roller (6, 6′) is lowered onto the warm rotating semi-finished product (1) and pushes material in a radial manner from the outside to the inside, wherein the pushed material first accumulates on the pin-shaped downholding unit (5) and the push roller (6, 6′) is actuated in such a manner that the accumulated material in the further process is forced upward along the pin-shaped downholding unit (5) in order for a hub/journal (8) to be generated. Two push rollers (6, 6′) which are disposed diametrically in order for the lateral forces acting on a main spindle (not illustrated here) that, for example, as a rotating drive (symbolized by the illustration of a rotating arrow) is connected to the die (4) to be able to be substantially compensated are preferably provided. A preform (3) having an upper geometric element (hub/journal) is thus created in a first operative step and/or tool (7) by means of roller spinning [FIG. 2]. In order for a premature cooling of the preform (3) that is to be generated to be prevented, the die (4) can be equipped with means for temperature controlling. In the course of the generation, or after the generation, of the preform (3) additional functional elements (not illustrated), for example toothing, in particular on the inside and/or on the outside in the region of the hub (8), grooves, threads, etc. in the region of the upper geometric element can be formed in the latter preferably in the first operative step or in a downstream separate method step by means of roller spinning. The die (4) can furthermore be thermally decoupled from further components (not illustrated), for example from the main spindle of the first tool (7) that is connected to the die (4), so as to substantially avoid any heating of the further components of the tool (7), which would have a negative effect in particular on the service life of said components.

In a further step of the method according to the invention the preform (3) having an upper geometric element, or a hub/journal (8), respectively, is at least in regions heated to a second temperature which is between 200° C. and 700° C., in particular before the preform (3) having an upper geometric element is processed in a second operative step and/or is arranged in or placed into a second tool (12). The heating at least in regions is preferably performed in an inductive manner by means of an inductor. The preform (3) having an upper geometric element is fed to a device that in a corresponding manner is equipped with at least one inductor (2) [FIG. 3], for example, or the inductor can be disposed on a feed device (not illustrated) which supplies the second tool (12) with the preform (3).

The warm preform (3) having an upper geometric element is transferred to the second tool (12) and is clamped so as to be secured against rotation between a tool core (13) and a downholding unit (9), for example. The tool core (13) and the downholding unit (9) are disposed so as to be actively rotatable in the second tool (12), this being symbolized by the illustration of a rotating arrow. At least one push roller (6, 6′) is lowered onto the warm rotating preform (3) having an upper geometric element and pushes material emanating from the hub/journal (8) of the preform (3) radially from the inside to the outside, wherein the material is pushed along the tool core (13), this being symbolized by the illustration of the arrow, wherein the push roller (6, 6′) is actuated in such a manner that a bell (14) is generated. A preform (11) having an upper geometric element or a hub/journal (8), respectively, and at least one lower geometric element, or a bell (14), respectively, is thus created in a second operative step and/or second tool (12) by means of roller spinning [FIG. 4]. In order for a premature cooling of the preform to be generated (11) to be prevented, the tool core (13) can be equipped with means for temperature controlling. The tool core (13) can furthermore be thermally decoupled from further components (not illustrated), for example from a main spindle of the second tool (12) that is connected to the tool core (13), so as to substantially avoid any heating of the further components of the tool (12), which would have a negative effect in particular on the service life of said components.

In a further step of the method according to the invention the preform (11) having an upper geometric element or a hub/journal (8), respectively, and at least one lower geometric element, or a bell (14), respectively, is at least in regions heated to a third temperature which is between 400° C. and 1000° C., in particular before the preform (11) is processed in a third operative step and/or is placed into or arranged in a third tool (16, 20). The heating at least in regions is preferably performed in an inductive manner by means of an inductor, preferably by means of an annular inductor (2′) which as is illustrated in FIG. 5 is disposed from the outside, in particular over the bell (14) of the preform (11) and heats the bell (14) at least in regions. Alternatively, an annular inductor can also be introduced on the inside into the bell of the preform so as to heat the bell from the inside. A linear inductor can also be disposed from the inside or from the outside in the region of the bell and heat at least the region of the bell of the preform. The preform (11) having an upper and at least one lower geometric element is fed to a device [FIG. 5] that in a corresponding manner is equipped with at least one inductor (2′), for example, or the inductor can be disposed on a feed device (not illustrated) which supplies a third tool (16, 20) with the preform (11) having an upper and at least one lower geometric element.

According to a first embodiment, the warm preform (11) having an upper and at least one lower geometric element is transferred to a third tool (16) and is clamped so as to be secured against rotation on a tool core (22), for example. The tool core (22) is disposed so as to be actively rotatable in the third tool (16), symbolized by the illustration of a rotating arrow. By way of at least one rest bar (23) and/or at least one profiling roller (17) which in each case have the external contour in the region of the bell (14) of the formed body (15) to be generated, and by way of the tool core (22) which has the internal contour in the region of the bell (14) of the formed body (15) to be generated, ball races (24) and/or a raceway (25) are/is profiled in the bell (14) on top of one another by means of roller spinning on account of the action of the at least one rest bar (23) and/or at least one profiling roller (17) and of the tool core (22). Alternatively and not illustrated here, two rest bars without or with two support rollers (not illustrated here) that are mutually offset by 90° for profiling can be used for profiling, on the one hand, or two to four profiling rollers without or with two support rollers (not illustrated) that are mutually offset by 90° can be used for profiling, on the other hand. If hardening is to be carried out during profiling, heating of the preform (11) at least in regions to a third temperature of at least Ac1 for partial austenitization, preferably to at least Ac3 for complete austenitization, is required. The profiling should be substantially completed before the formed body (15) reaches the temperature of the start of martensite transformation (Ms), and the hardening, or the conversion of the austenite structure to martensite structure has been performed, respectively. Depending on the conception of the tool (16), at least the tool core (22) can be equipped with means for active cooling so as to be able to provide the required cooling rate for the martensite transformation. Alternatively or additionally, means for temperature controlling can also be provided. Alternatively, the hardening in temporal terms can be performed after profiling, wherein the third temperature in this instance is limited to a maximum of 700° C., in particular to a maximum of 580° C. Furthermore, the tool core (22) can be thermally decoupled from further components (not illustrated), for example from a main spindle of the third tool (16) that is connected to the tool core (22), so as to substantially avoid any heating of the further components of the tool (16), which could have a negative effect in particular on the service life of said components. The hardening can then be performed in a further method step by the austenitization of the formed body (15), for example in a furnace and quenching, for example in a water or oil bath. According to a further alternative embodiment, boundary hardening at least in regions, in particular in the internal region of the profiled bell (10), preferably at least in the region of the ball races (24), can also be carried out on the formed body. The formed body (15) has at least one hub/journal (8) which can comprise further functional elements having at least one profiled bell (10).

According to an alternative second embodiment, the warm preform (11) having an upper and at least one lower geometric element is transferred to a third tool (20) and is clamped so as to be secured against rotation on a tool core (21), for example. The tool core (21) is disposed so as not to be rotatable in the third tool (20). By way of at least one forming slide element (18), preferably a plurality of forming slide elements (18), which are radially displaceable and symbolized by the illustration of the arrow and which are disposed between die elements (19) and have the external contour in the region of the bell (14) of the formed body (15′) to be generated, and by way of the tool core (21) which has the internal contour in the region of the bell (14) of the formed body (15′) to be generated, ball races (24′) and/or a raceway (25′) are profiled in the bell (14) on account of the action of the at least one forming slide element (18) and/or at least one die element (19) and the tool core (21) on top of one another. The drive of the at least one forming slide element (18) is performed, for example, mechanically by way of slides that are configured in a corresponding manner and/or by means of hydraulics. If hardening is to be carried out during profiling, heating of the preform (11) at least in regions to a third temperature of at least Ac1 for partial austenitization, preferably to at least Ac3 for complete austenitization, is required. The profiling should be substantially completed before the formed body (15′) reaches the temperature of the start of martensite transformation (Ms), and the hardening, or the conversion of the austenite structure to martensite structure has been performed, respectively. Depending on the conception of the tool (20), at least the tool core (21) can be equipped with means for active cooling so as to be able to provide the required cooling rate for the martensite transformation. Alternatively or additionally, means for temperature controlling can also be provided. Alternatively, the hardening in temporal terms can be performed after profiling, wherein the third temperature in this instance is limited to a maximum of 700° C., in particular to a maximum of 580° C. Furthermore, the tool core (21) can be thermally decoupled from further components (not illustrated), so as to substantially avoid any heating of the further components of the tool (20), which could have a negative effect in particular on the service life of said components. The hardening can then be performed in a further separate method step by the austenitization of the formed body (15′), for example in a furnace and quenching, for example in a water or oil bath. According to a further alternative embodiment, boundary hardening at least in regions, in particular in the internal region of the profiled bell (10′), preferably at least in the region of the ball races (24′), can be also carried out on the formed body. The formed body (15′) has at least one hub/journal (8) which can comprise further functional elements having at least one profiled bell (10′).

The invention is not limited to the exemplary embodiments illustrated in the drawing; rather, other, in particular rotationally symmetrical, formed bodies can also be produced by the method according to the invention.

### LIST OF REFERENCE SIGNS

1 Round semi-finished product

2, 2′ Inductor

3 Preform having an upper geometric element

4 Die

5 Pin-shaped down holding unit

6, 6′ Push roller

7 First tool

8 Upper geometric element, hub, journal

9 Downholding unit

10, 10′ Profiled bell, lower profiled geometric element

11 Preform having an upper and a lower geometric element

12 Second tool

13, 21, 22 Tool core

14 Lower geometric element, bell

15, 15′ Formed body

16, 20 Third tool

17 Profiling roller

18 Forming slide element

19 Die element

23 Rest bar

24, 24′ Ball races

25, 25′ Raceway

1.-10. (canceled)

11. A method for producing a formed body, the method comprising the steps of:
providing a preformed semi-finished product made of a steel material;
heating the semi-finished product at least in regions to a first temperature;
forming a hub on the heated semi-finished product in a first operative step by roller spinning, for producing a first preform having an upper geometric element;
heating or re-heating the first preform at least in regions to a second temperature;
forming a bell on the heated first preform in a second operative step by roller spinning, for producing a second preform having the upper geometric element and at least one lower geometric element;
heating or re-heating the second preform at least in regions to a third temperature; and
profiling the heated second preform for producing the formed body in a third operative step.

12. The method as claimed in claim 11, wherein at least one of the first temperature and the second temperature is between 200° C. and 700° C.

13. The method as claimed in claim 11, wherein the third temperature is between 400° C. and 1000° C.

14. The method as claimed in claim 11, further comprising actively controlling temperature during forming the hub on the heated semi-finished product in the first operative step and during forming the bell on the heated first preform in the second operative step.

15. The method as claimed in claim 11, wherein the steps of forming the hub on the heated semi-finished product, forming the bell on the heated first preform, and profiling the heated second preform are each performed in one step or a plurality of operative steps.

16. The method as claimed in claim 11, wherein the formed body is formed as a joint journal or axle journal.

17. The method as claimed in claim 11, wherein the formed body is hardened at least in regions during or after the profiling step.

18. The method as claimed in claim 11, wherein the heating the semi-finished product, heating or re-heating the first preform, and heating or re-heating the second preform are performed in an inductive manner.

19. The method as claimed in claim 11, wherein the steel material comprises hardening-capable steel material which, in a tempered state, has a hardness of at least 50 HRC.

20. The method as claimed in claim 11, wherein a boundary hardening is carried out on the formed body at least in regions.

21. The method as claimed in claim 11, wherein the preformed semi-finished product is circular.

22. The method as claimed in claim 11, wherein the first operative step occurs in a first tool.

23. The method as claimed in claim 11, wherein the second operative step occurs in a second tool.

24. The method as claimed in claim 11, wherein the third operative step occurs in a third tool.

25. The method as claimed in claim 12, wherein at least one of the first temperature and the second temperature is between 250° C. and 580° C.

26. The method as claimed in claim 13, wherein the third temperature is between 480° C. and 950° C.

27. The method as claimed in claim 14, wherein the step of actively controlling temperature comprises actively controlling temperature in a first tool in which the first operative step occurs and actively controlling temperature in a second tool in which the second operative step occurs.

28. The method as claimed in claim 11, wherein the profiling step is performed at least in regions in one of the lower geometric element or the bell of the second preform.

29. The method as claimed in claim 28, wherein the profiling step results in a configuration of at least one raceway and/or ball races in the third operative step

30. The method as claimed in claim 20, wherein the boundary hardening is carried out in an internal region of the bell on the formed body.
